(19) United States
(12) Patent Application Publication
(10) Pub. No.: US 2025/0106616 A1
(43) Pub. Date: Mar. 27, 2025

(54) METHOD OF COLLECTING DATA BASED ON USER PLANE

(71) Applicant: SAMSUNG ELECTRONICS CO., LTD., Suwon-si (KR)

(72) Inventors: Sangjun MOON, Suwon-si (KR); Hyesung KIM, Suwon-si (KR); Dongeun SUH, Suwon-si (KR); Hoyeon LEE, Suwon-si (KR)

(21) Appl. No.: 18/898,480

(22) Filed: Sep. 26, 2024

(30) Foreign Application Priority Data
Sep. 26, 2023 (KR) 10-2023-0129826

(51) Int. Cl. H04W 8/20; H04M 15/00; H04W 4/38; H04W 64/00

(52) U.S. Cl. CPC H04W 8/20; H04M 15/66; H04W 4/38; H04W 64/00

(57) ABSTRACT

Provided is an operation method of an access and mobility management function (AMF) in a wireless communication system, the operation method including receiving a subscription request from a sensing function (SF), receiving subscription information for each user equipment (UE) from unified data management (UDM) and checking whether each UE is able to support a sensing service, identifying, based on the subscription information and whether each UE is able to support the sensing service, at least one base station or at least one UE that satisfies a location condition, and transmitting, to the SF, information related to the identified at least one base station or at least one UE and the corresponding location condition.

### CROSS-REFERENCE TO RELATED APPLICATION

This application is based on and claims priority under 35 U.S.C. § 119 to Korean Patent Application No. 10-2023-0129826, filed on Sep. 26, 2023, in the Korean Intellectual Property Office, the disclosure of which is incorporated by reference herein in its entirety

### BACKGROUND

### 1. Field

The disclosure relates to a method of providing a sensing service in a wireless communication system. More particularly, the disclosure relates to a method of sensing an object by utilizing base stations built for existing communications and terminals that may also be utilized for communications.

### 2. Description of Related Art

Considering the development of wireless communication from generation to generation, technologies have been developed mainly for services targeting humans, such as voice calls, multimedia services, data services, etc. After the commercialization of 5^{th}-generation (5G) communication systems, an exponentially increasing number of connected devices are projected to be connected to communication networks. Examples of objects connected to networks may include vehicles, robots, drones, home appliances, displays, smart sensors installed in various infrastructures, construction machinery, factory equipment, etc. Mobile devices are expected to evolve into a variety of form factors such as augmented reality (AR) glasses, virtual reality (VR) headsets, and hologram devices, etc. In the 6^{th}-generation (6G) era, efforts are being made to develop improved 6G communication systems to provide various services by connecting hundreds of billions of devices and objects. For these reasons, a 6G communication system is referred to as a beyond 5G communication system.

In a 6G communication system predicted to be commercialized around 2030, a peak data rate is terabyte per second (Tbps) (i.e., 1000 gigabytes per second (Gbps)), and a maximum air interface latency is 100 microseconds (μsec). That is, in the 6G communication system, the transfer rate becomes 50 times faster and the radio latency is reduced to one-tenth of the 5G communication system.

Implementation of 6G communication systems in a terahertz (THz) band (such as a frequency range between 95 gigahertz (GHz) and 3 THz) is under consideration to achieve such high data rate and ultra-low latency. In the THz band, the importance of technologies for guaranteeing a signal transmission distance, i.e., coverage, is expected to increase due to more severe path loss and atmospheric absorption compared to a millimeter-wave (mmWave) band introduced in 5G. It is necessary to develop, as the major technologies for securing coverage, radio frequency (RF) elements, antennas, novel waveforms which have better coverage than orthogonal frequency division multiplexing (OFDM), beamforming, multiple antenna transmission technologies, such as multiple input and multiple-output (massive MIMO), full dimensional MIMO (FD-MIMO), array antennas, and large scale antennas, and the like. In addition, novel technologies such as metamaterial-based lenses and antennas, high-dimensional spatial multiplexing technology using orbital angular momentum (OAM), reconfigurable intelligent surface (RIS), etc. have been discussed to improve the coverage of signals in the THz band.

Furthermore, to improve frequency efficiency and system networks for 6G communication systems, various technologies are being developed which include a full duplex technology for enabling uplink transmission and downlink transmission to simultaneously use the same frequency resource at the same time, a network technology using integration of satellites and high-altitude platform stations (HAPSs), a network structure innovation technology that supports mobile base stations and the like and enables optimization, automation, etc., of network operations, a dynamic spectrum sharing technology for avoiding collisions based on spectrum usage prediction, artificial intelligence (AI)-based communication technologies that utilize AI from the design stage and internalize end-to-end AI support functions to realize system optimization, and next-generation distributed computing technologies that realize services of a complexity level beyond the limits of user equipment (UE) computing capabilities by utilizing ultra-high performance communication and computing resources (mobile edge computing (MEC), cloud, etc.). In addition, ongoing attempts are being made to further enhance a connectivity between devices, further optimize networks, promote the softwarization of network entities, and increase the openness of wireless communications through the design of new protocols to be used in 6G communication systems, implementation of hardware-based security environments, development of mechanisms for safe use of data, and development of technologies on a method of maintaining privacy.

With the research and development of these 6G communication systems, the next hyper-connected experience is expected to be provided through hyper-connectivity of the 6G communication systems, which includes not only connectivity between things but also connectivity between humans and things. Specifically, 6G communication systems are expected to provide services such as truly immersive extended reality (XR), high-fidelity mobile holograms, digital replica, etc. In addition, by providing services such as remote surgery, industrial automation, and emergency response via the 6G communication systems through enhancement of security and reliability, such technologies may be applied in various fields such as industry, medical care, automobiles, home appliances, etc.

### SUMMARY

According to an embodiment of the disclosure, a method and device capable of effectively providing a service in a wireless communication system may be provided.

Additional aspects will be set forth in part in the description which follows and, in part, will be apparent from the description, or may be learned by practice of the presented embodiments of the disclosure.

As a solution to the above technical problem, an operation method of an access and mobility management function (AMF) in a wireless communication system includes receiving a subscription request from a sensing function (SF), receiving subscription information for each user equipment (UE) from unified data management (UDM) and checking whether each UE is able to support a sensing service, identifying, based on the subscription information and whether each UE is able to support the sensing service, at least one base station or at least one UE that satisfies a location condition, and transmitting, to the SF, information related to the identified at least one base station or at least one UE and the corresponding location condition.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates 3GPP integrated sensing and communication modes according to various embodiments of the present disclosure;

FIG. 2 illustrates a sensing data collection method using a user plane in integrated sensing and communications according to various embodiments of the present disclosure;

FIG. 3 illustrates a method of a sensing function for collecting data for 3GPP integrated sensing and communication according to various embodiments of the present disclosure;

FIGS. 4A and 4B illustrate a sensing data collection operation using a user plane in a case where a UE is a Rx according to various embodiments of the present disclosure;

FIGS. 5A and 5B illustrate a sensing data collection operation using a user plane in a case where a gNB is Rx according to various embodiments of the present disclosure; and

FIG. 6 illustrates a network entity according to various embodiments of the present disclosure.

### DETAILED DESCRIPTION

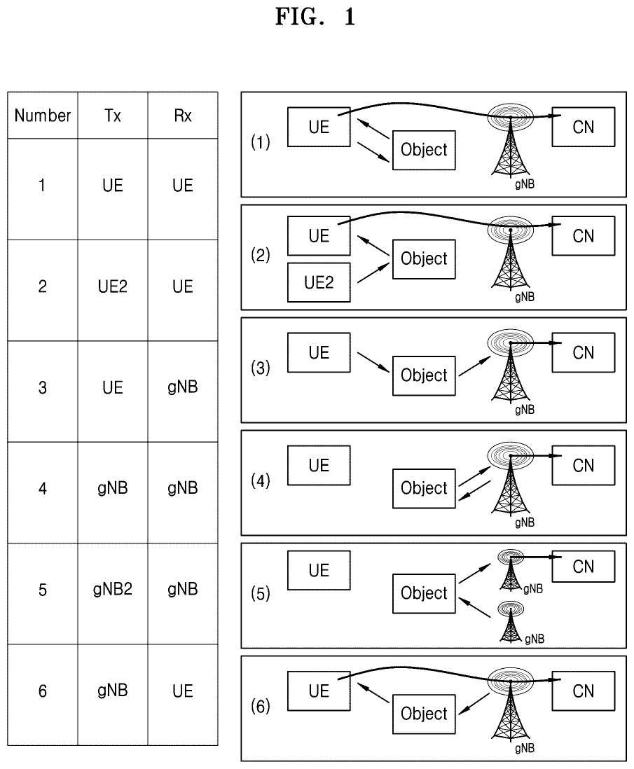

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

In the following description of embodiments of the disclosure, descriptions of technical features that are well known in the art to which the disclosure pertains and are not directly related to the disclosure are omitted. This is for clearly describing the essence of the disclosure without obscuring it by omitting the unnecessary descriptions.

Advantages and features of the disclosure and methods of accomplishing the same will be more readily appreciated by referring to the following description of embodiments of the disclosure and the accompanying drawings. However, the disclosure may be embodied in many different forms and should not be construed as being limited to embodiments of the disclosure set forth below.

Throughout the disclosure, the expression “at least one of a, b or c” indicates only a, only b, only c, both a and b, both a and c, both b and c, all of a, b, and c, or variations thereof.

As used in the following description, terms identifying access nodes, terms indicating network entities, terms indicating messages, terms indicating interfaces between network entities, terms indicating various types of identification information, etc. are exemplified for convenience of description. Accordingly, the disclosure is not limited to terms described below, and other terms representing objects having equivalent technical meaning may be used.

Hereinafter, for convenience of description, the disclosure uses terms and names defined in the 3rd generation partnership project new radio (3GPP NR) specifications. However, the disclosure is not limited by the terms and names but may also be equally applied to systems that comply with other standards. As used herein, a base station may represent a next-generation Node B (gNB). Furthermore, the term ‘terminal’ may refer to mobile phones, narrowband Internet of Things (NB-IOT) devices, sensors, and other wireless communication devices.

Hereinafter, a base station is an entity that allocates resources to a terminal, and may be at least one of a gNodeB (or gNB), an eNodeB (eNB), a Node B, a base station (or BS), a radio access unit, a base station controller, or a network node. A terminal may include a user equipment (UE), a mobile station (MS), a cellular phone, a smartphone, a computer, or a multimedia system capable of performing a communication function. However, the base station and the terminal are not limited to the above examples.

In particular, the disclosure may be applied to the 3GPP NR standard (the 5^{th}-generation (5G) mobile communications standard). Furthermore, the disclosure may be applied to intelligent services (e.g., smart homes, smart buildings, smart cities, smart cars or connected cars, health care, digital education, retail businesses, security and safety related services, etc.) based on the 5G communication technology and IoT related technology.

Wireless communication systems have progressed beyond providing initial voice-centered services into broadband wireless communication systems that provide high-speed, high-quality packet data services based on communication standards such as high speed packet access (HSPA) in 3GPP, long-term evolution (LTE) or evolved universal terrestrial radio access (E-UTRA), LTE-advanced (LTE-A), LTE-pro, high rate packet data (HRPD) in 3GPP2, ultra mobile broadband (UMB), and the institute of electrical and electronic engineers (IEEE) 802.16e.

As a representative example of a broadband wireless communication system, an LTE system adopts an orthogonal frequency division multiplexing (OFDM) scheme for downlink (DL) and a single carrier frequency division multiple access (SC-FDMA) scheme for uplink (UL). UL refers to a radio link through which a UE (or a MS) transmits data or a control signal to a base station (an eNB or a BS), and DL refers to a radio link through which the base station transmits data or a control signal to the UE. In the multiple access schemes as described above, data or control information of each user may be identified by allocating and operating time-frequency resources carrying the data or the control information for each user to prevent overlapping i.e., obtain orthogonality between the time-frequency resources.

Because a post-LTE communication system, i.e., a 5G communication system, needs to be able to freely reflect various requirements from users, service providers, etc., the 5G communication system is required to support services that simultaneously satisfy the various requirements. Services being considered for 5G communication systems include enhanced mobile broadband (eMBB), massive machine type communication (mMTC), ultra-reliable low-latency communication (URLLC), etc.

Furthermore, although embodiments of the disclosure are described below using an LTE, LTE-A, LTE Pro, or 5G (or NR or next-generation mobile communication) system as an example, the embodiments of the disclosure may be applied to other communication systems having similar technical backgrounds and channel configurations. It will also be understood by a person skilled in the art that embodiments of the disclosure are applicable to other communication systems through some modifications not greatly departing from the scope of the disclosure.

In the following description of the disclosure, when it is determined that detailed descriptions of related known functions or configurations may unnecessarily obscure the subject matter of the disclosure, the descriptions thereof will be omitted. Hereinafter, embodiments of the disclosure are described in detail with reference to the accompanying drawings.

An embodiment of the disclosure relates to a method of providing a sensing service via a wireless communication network, and more particularly, via a 3GPP 5G system (5GS). In particular, the disclosure relates to a method of sensing an object by utilizing base stations built for existing communications and terminals that may also be utilized for communications. For this purpose, a method of collecting sensing data from a UE or gNB that supports a sensing functionality using 5G NR is required.

Hereinafter, operation principles of the disclosure will be described in detail with reference to the accompanying drawings. In the following description of the disclosure, when it is determined that detailed descriptions of related known functions or configurations may unnecessarily obscure the subject matter of the disclosure, the descriptions thereof will be omitted. Furthermore, the terms described below are defined by taking into account functions described in the disclosure and may be changed according to a user's or operator's intent or customs. Therefore, definition of the terms should be made based on the overall descriptions in the present specification.

As used in the following description, terms identifying access nodes, terms indicating network entities, terms indicating messages, terms indicating interfaces between network entities, terms indicating various types of identification information, etc. are exemplified for convenience of description. Accordingly, the disclosure is not limited to terms described below, and other terms representing objects having equivalent technical meaning may be used.

Hereinafter, for convenience of description, the disclosure uses terms and names defined in the 5GS and NR specifications which are the latest standards defined by the 3GPP organization among the existing communication standards. However, the disclosure is not limited by the above terms and names, and may be equally applied to wireless communication networks according to other standards. In particular, the disclosure may be applied to the 3GPP 5GS/NR (5G mobile communication standard).

By using a wireless communication network, more specifically, a 3GPP 5GS, it is possible to provide sensing services such as detecting intrusion into a specific area or detecting vehicles passing through a specific area and periodically notifying a detection result. In other words, base stations built for existing communications and terminals that may also be used for communications are used to sense an object. For sensing, a sensing entity (or sensing entities) discovers an object (or objects) that needs to be sensed. The sensing service is implemented by diffracting/refracting/reflecting signals generated by a transmitting (Tx) sensing entity by an object, receiving the diffracted/refracted/reflected signals by a receiving (Rx) sensing entity, and transmitting/collecting/processing these received signals to obtain a final result. In order to provide a sensing service via a 5GS, there is a need for a method of first finding UEs or gNBs that support the sensing functionality by using 5G NR, and collecting sensing data from Rx sensing entities among the found UEs or gNBs into the 5GS.

FIG. 1 illustrates 3GPP integrated sensing and communication modes according to various embodiments of the present disclosure.

In order to provide sensing services via a 3GPP 5GS, a UE or gNB that supports a sensing functionality using 5G NR may be used as a sensing entity. In addition, sensing entities may be largely divided into two groups based on their roles, i.e., Tx sensing entities which generate signals and Rx sensing entities that receive signals. Six (6) sensing modes, as shown below, may be configured by broadly dividing the sensing entities into the two groups according to whether a Tx sensing entity is a UE or gNB, and further dividing the two groups into smaller groups according to whether an Rx sensing entity is a UE or a gNB.

Sensing mode 1: A UE is a transmitter (Tx), the same UE is a receiver (Rx), and the Rx UE transmits sensing data to the core network (CN).

Sensing mode 2: A UE2 is Tx, another UE is Rx, and the Rx UE transmits sensing data to the CN.

Sensing mode 3: A UE is Tx, a gNB is Rx, and the Rx gNB transmits sensing data to the CN.

Sensing mode 4: A gNB is Tx, the same gNB is Rx, and the Rx gNB transmits sensing data to the CN.

Sensing mode 5: A gNB2 is Tx, another gNB is Rx, and the Rx gNB transmits sensing data to the CN.

Sensing mode 6: A gNB is Tx, a UE is Rx, and the Rx UE transmits sensing data to the CN.

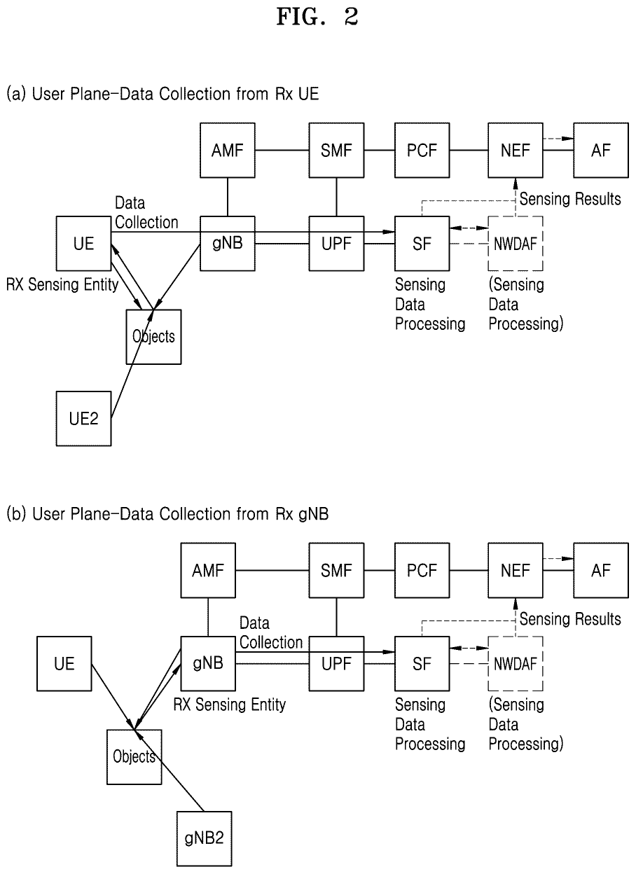

FIG. 2 illustrates a sensing data collection method using a user plane in integrated sensing and communications according to various embodiments of the present disclosure.

When an Rx UE receives a signal diffracted/refracted/reflected by an object, such as in sensing mode 1, 2, or 6, data collection may be performed using the user plane as shown in (a) of FIG. 2. Sensing data is transmitted from the UE though the gNB to a user plane function (UPF) via the user plane, and then the UPF transmits the sensing data to a sensing function (SF). The SF may process the collected sensing data, and when a processing result satisfies a specific condition, report the processing result to a specific network function (NF) such as an application function (AF). The SF may transmit the processing result to a network data analytics function (NWDAF) for further processing as needed, or receive the processing result back from the NWDAF for further processing.

Like in sensing mode 1, a UE may generate a signal, and the same UE may receive the signal, and as the Rx UE, transmit sensing data to the CN. Like in sensing mode 2, a UE2 may generate a signal, and a UE may receive the signal, and as the Rx UE, transmit sensing data to the CN. Like in sensing mode 6, a gNB may generate a signal, and a UE may receive the signal, and as the Rx UE, transmit sensing data to the CN.

When an Rx gNB receives a signal diffracted/refracted/reflected by an object like in sensing mode 3,4, or 5, data collection may be performed using the user plane as shown in (b) of FIG. 2. Sensing data is transmitted from the gNB to the UPF via the user plane, and then the UPF transmits the sensing data to the SF. The SF may process the collected sensing data, and when a specific condition is satisfied, report a processing result to a specific NF such as an AF. The SF may transmit the processing result to an NWDAF for further processing as needed, or receive the processing result back from the NWDAF for further processing.

Like in sensing mode 3, the UE may generate a signal, and a gNB may receive the signal, and as the Rx gNB, transmit sensing data to the CN. Like in sensing mode 4, a gNB may generate a signal, and the same gNB may receive the signal, and as the Rx gNB, transmit sensing data to the CN. Like in sensing mode 5, a gNB2 may generate a signal, and a gNB may receive the signal, and as the Rx gNB, transmit sensing data to the CN.

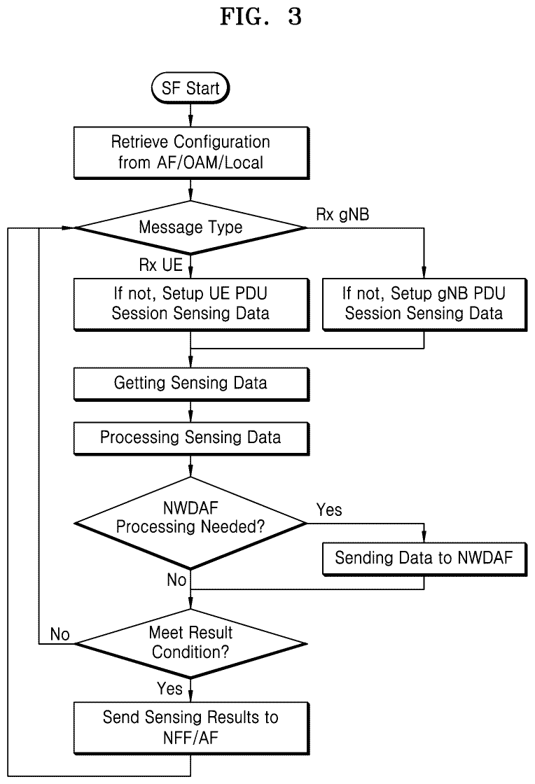

FIG. 3 illustrates a method of an SF for collecting data for 3GPP integrated sensing and communication according to various embodiments of the present disclosure.

The SF identifies a configuration set via a request from an AF, via operation, administration, and management (OAM), or as prestored content. This configuration, for example, a sensing service request via the AF may include the following:
Service/requester authentication/authorization information: Authorization needs to be successful in this operation for subsequent operations to proceed;
Service priority: It is necessary to check whether there is a priority requirement within the service request;
Service profile/area of service (AoS)->radio access network (RAN)/UE: A service area may be specified to indicate gNBs and UEs corresponding to sensing entities within the service area, and service accuracy may be specified to affect the number of gNBs and the number of UEs required for this. The service accuracy may include an error probability, an error radius for a location, valid time for reporting, etc.;
Sensing mode: This may be configured by explicitly indicating the six modes described with reference to FIG. 1;
Capability negotiation: The mode or the number of gNBs/UEs may be additionally changed; and/or
Sensor discovery and selection: The sensing entities that satisfy all of the processes are finally determined.

Through this request, the SF may additionally identify the required network configuration. For example, a sensing request transmitted by the AF to a network exposure function (NEF) may include a location/geographical condition, a time condition, accuracy requirements, etc. More specifically, the sensing request may include the following parameters:
Location;
Activation/deactivation time;
Service requester (for authentication to provide the service);
Installed sensors in the location (UE types and RAN node);
Sensor identifiers (IDs);
required AoS (statically or dynamically configured);
Minimum/maximum number of sensors;
Assistance information; and/or
Who-will-get-notification.

Accordingly, by selecting a required sensing entity and selecting a sensing mode, the SF may determine whether to collect sensing data by using an Rx UE, an Rx gNB, or a combination of these as described above with reference to FIG. 2. In case that the Rx UE is used, a protocol data unit (PDU) session between UE-gNB-UPF may be set up to collect sensing data from the Rx UE, and a connection from the UPF to the SF may be established. In case that the Rx gNB is used, a PDU session or a special data transfer session to the UPF may be set up to collect sensing data from the Rx gNB, and a connection from the UPF to the SF may be established.

Through the path set up in this way, the SF may collect sensing data from the Rx UE or Rx gNB through the user plane. The SF may process the collected sensing data into sensing results and, when the sensing results meet a specific condition, notify the sensing results to an NF such as the AF. When it is necessary to request sensing data processing from additional NFs such as NWDAF, etc., the SF may process the sensing data as is or in part and transmit a result to the NWDAF, etc. according to a condition, and receive a result of further processing from the NWDAF, etc. Then, when the sensing data is processed again into sensing results, and the sensing results meet the specific condition, the SF may notify the sensing results to an NF such as the AF.

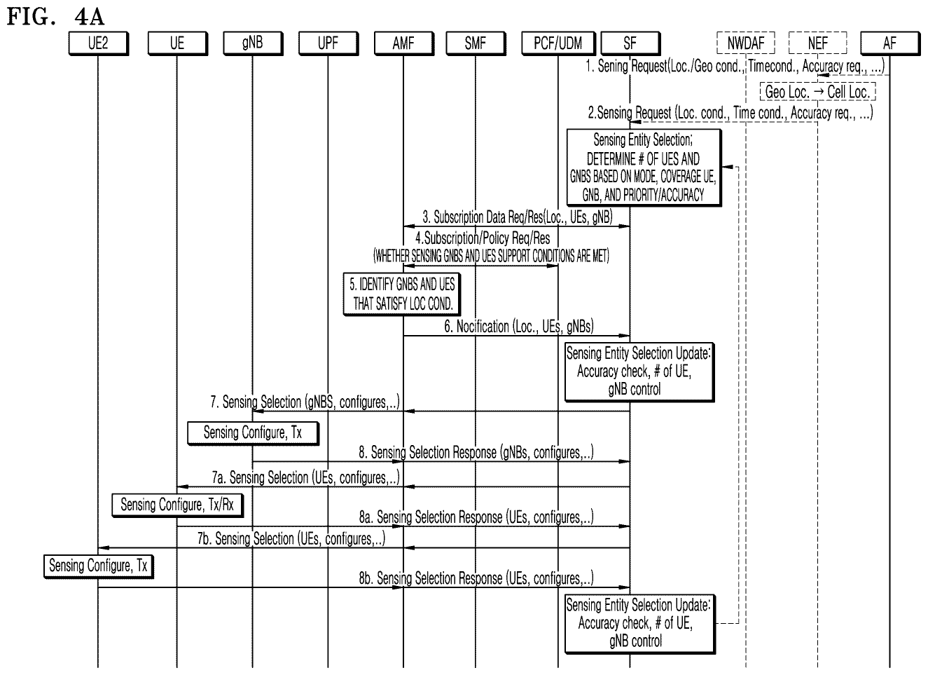

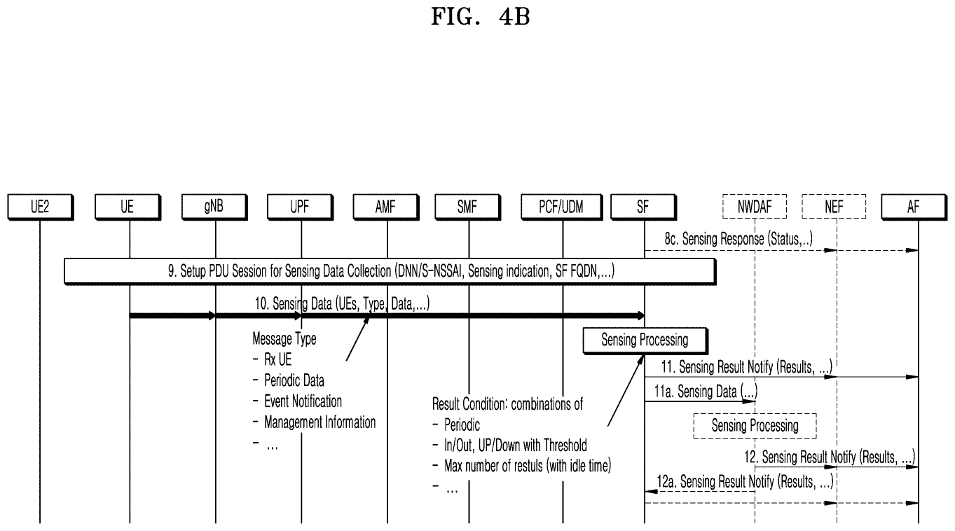

FIGS. 4A and 4B illustrate a sensing data collection operation using a user plane in a case where a UE is Rx according to various embodiments of the present disclosure.

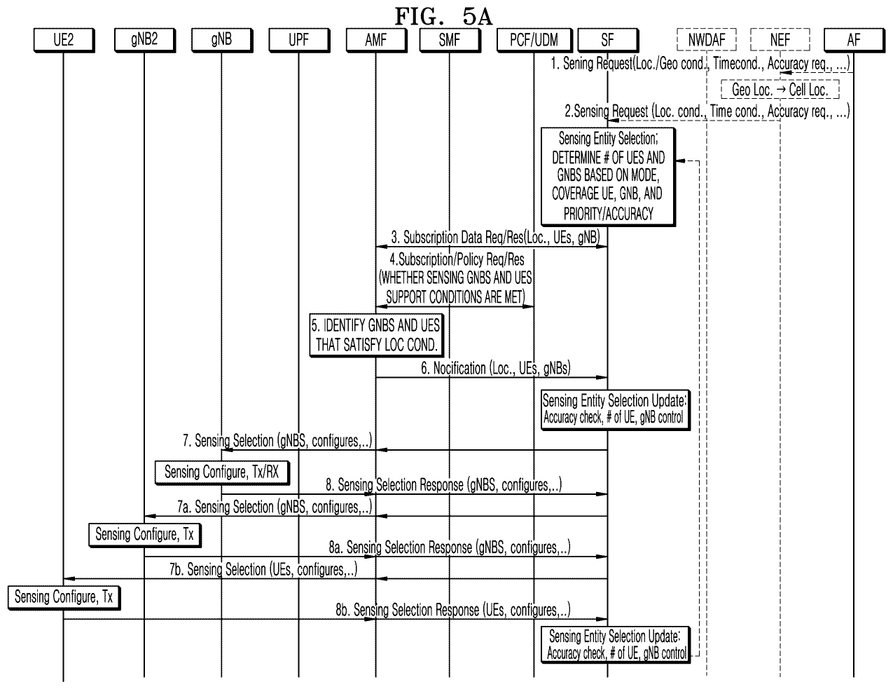

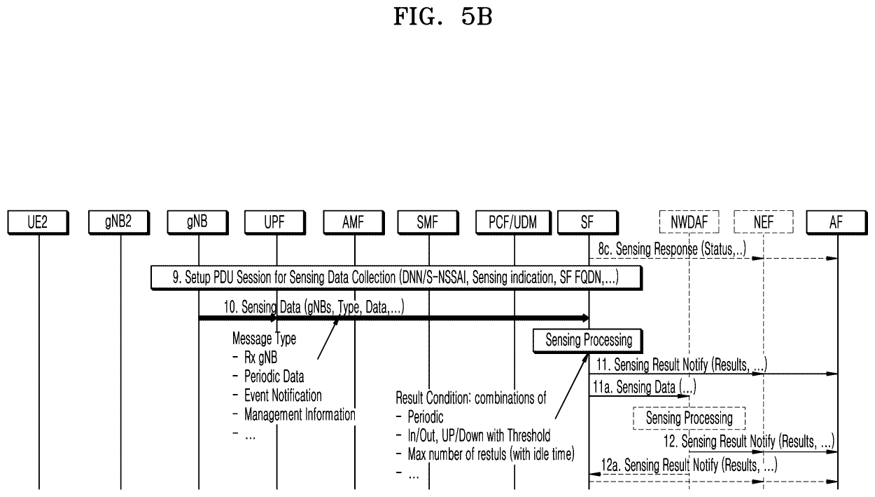

FIGS. 4A and 4B correspond to a case where an Rx UE receives a signal diffracted/refracted/reflected by an object, as in sensing mode 1, 2, or 6. Depending on a sensing mode actually selected, a process of FIGS. 4A and 4B may be combined and utilized with a process of FIGS. 5A and 5B described below. This process may also be automatically changed and applied in response to changes in the environment, such as a change in the state of a network or movement of UEs.

In operation 1, an AF may transmit a sensing request to an NEF. In this case, the sensing request may include a location/geographical condition, a time condition, accuracy requirements, etc. Specifically, the sensing request may further include the following parameters:
Location;
Activation/deactivation time;
Service requester (for authentication to provide the service);
Installed sensors in the location (UE types and RAN node);
Sensor IDs;
required AoS (statically or dynamically);
Minium/maximum number of sensors;
Assistance information;
Who-will-get-notification; and/or
results conditions.

In operation 2, the NEF may convert a geographical location condition in a location condition to a condition used in 3GPP, such as a cell location condition or the like. The NEF then transmits the sensing request received in operation 1 to an SF that is capable of collecting/processing sensing information. In this case, information included in the sensing request is the same as that received in operation 1, but the converted location condition is used as the location condition. Operation 2 may be omitted when the AF has a close relationship with a 5GS. When operation 2 is omitted, the location condition provided by the AF is a cell location condition or the like used in the 3GPP.

In operation 3, the SF may initially perform a sensing entity selection process. That is, the SF determines the number of UEs and the number of gNBs, based on a mode, a coverage UE, a gNB, and a priority/accuracy. The SF then transmits, to an AMF, a Subscription Request to continuously report information about UEs and gNBs that meet the location condition, and receives initially required information in a response.

In operation 4, the AMF retrieves subscription information for each UE from unified data management (UDM) and checks whether each UE is able to support a sensing service. In addition, the AMF may check information with a policy control function (PCF) to check a policy condition to identify whether each UE is able to provide the sensing service. That is, the AMF receives information such as information about whether a UE collects sensor data by using the control plane or the user plane when the UE transmits the sensing data to the CN. Because gNBs may also be utilized as sensing entities, when information about whether each gNB may be utilized as a sensing entity is recorded in the UDM, the AMF checks and retrieves this information from the UDM. When information about whether each gNB may be utilized as a sensing entity is recorded in the PCF, the AMF checks and retrieves this information from the PCF.

In operation 5, the AMF may identify gNBs and UEs that satisfy the location condition by taking into account the conditions identified in operation 4.

In operation 6, the AMF may notify the SF of the gNBs and UEs identified in operation 5 along with the location condition. The SF may update the sensing entity selection process. That is, the SF checks whether the accuracy condition is to be satisfied and controls the number of UEs and the number of gNBs.

In operation 7, the SF may transmit a sensing selection request to gNBs by reflecting a determination result in operation 6. The sensing selection request may include target gNBs and configuration parameters. The configuration parameters are parameters required for the gNBs to be utilized as Tx sensing entities, and may include Tx frequency, sensing data report interval, whether to use the control plane for sensing data reporting, and an AMF ID, a session management function (SMF) ID, SF ID, a sensor ID, a sensing service ID, etc. when using the control plane. The configuration parameters may include whether to use the user plane for sensing data reporting, and when using the user plane, the required UPF ID, an SF ID, a session ID, an SMF ID, an SF ID, a sensor ID, a sensing service ID, etc.

In operation 8, each gNB performs a sensing configuration according to the information received in operation 7 so that the gNB may act as a Tx sensing entity, and transmits, to the SF, a sensing selection response indicating completion of the sensing configuration. In this operation, an ID of each gNB may be included again in addition to the parameters received in operation 7. When the state of the gNB changes due to increased load, etc., making it difficult to fulfill the request received in operation 7, the gNB notifies the SF of this situation.

In operation 7a, the SF may transmit a sensing selection request to UEs by reflecting the determination result in operation 6. The sensing selection request may include target UEs and configuration parameters. The configuration parameters are parameters required for the UEs to be utilized as Tx and Rx sensing entities, and may include Tx/Rx frequency, sensing signal generation period, sensing data report interval, whether to use the control plane for a sensing data reporting, and an AMF ID, an SMF ID, an SF ID, a sensor ID, a sensing service ID, etc. required when using the control plane. The configuration parameters may include whether to use the user plane for a sensing data reporting, and an UPF ID, an SF ID, a session ID, an SMF ID, an SF ID, a sensor ID, a sensing service ID, etc., required when using the user plane.

In operation 8a, each UE may perform a sensing configuration according to the information received in operation 7a so that the UE may act as a Tx/Rx sensing entity, and transmit, to the SF, a sensing selection response indicating completion of the sensing configuration. In this operation, an ID of each UE may be included again in addition to the parameters received in operation 7a. When the state of the UE changes due to increased load, movement of the UE, etc., making it difficult to fulfill the request received in operation 7a, the UE notifies the SF of this situation.

In operation 7b, the SF may transmit a sensing selection request to UEs by reflecting the determination result in operation 6. The sensing selection request may include target UE2s and configuration parameters. The configuration parameters are the parameters required for the UE2s to be utilized as Tx sensing entities and may include Tx frequency, sensing signal generation period, etc.

In operation 8b, each UE2 performs a sensing configuration according to the information received in operation 7b so that the UE2 may act as a Tx sensing entity, and transmits, to the SF, a sensing selection response indicating completion of the sensing configuration. In this operation, an ID of each UE2 may be included again in addition to the parameters received in operation 7b. When the state of the UE2 changes due to increased load, movement of the UE2, etc., making it difficult to fulfill the request received in operation 7b, the UE2 notifies the SF of this situation.

In operation 8c, the SF performs a sensing entity selection update process according to the results obtained in operations 8, 8a, and 8b. The SF checks the accuracy condition and controls the number of UEs and the number of gNBs. In this operation, when it is determined that the accuracy condition is not to be satisfied, the process may return to operation 3 in order to proceed. Then, when the sensing configuration is completed, the SF may transmit a response to the sensing request to the AF in operation 1 via the NEF.

In operation 9, each UE may operate as an Rx sensing entity according to the information received in operation 7a, and use the user plane to transmit sensing data to the SF. In this case, the sensing data may be transmitted from the UE to the SF via the gNB and the UPF. Depending on the information received in operation 7a, additional signaling may be required to secure a transmission path required for transmitting the sensing data. The UE sets up a PDU session from the UE to the UPF via the gNB, and establishes a connection from the UPF to the SF. To set up this PDU session, the signaling may include data network name (DNN)/single-network slice selection assistance information (S-NSSAI), a sensing indication, and fully qualified domain name (FQDN) of the SF. In this case, special QoS settings for transmission of the sensing data may be applied to the PDU session. In the special QOS settings, information about whether the sensing data is periodic data and a delay for transmission of Notification may be used.

In operation 10, the SF receives the sensing data via the path secured in operation 9 and collects/processes the received sensing data. The sensing data may include a transmitting UE ID, a message type, and actual data. The message type may indicate periodic data, an event notification, management information, etc. in addition to indicating the Rx UE. The periodic data may include whether the data is periodic, how long the period is, and the time to be used without the data being transmitted during the period. In the case of event notification format, a priority, a processing delay tolerance, etc. may be additionally included. The management information indicates whether the data is purely sensing data or information required for the management of a sensing entity. The information required for the management of the sensing entity may additionally include a reset request, a stop request, a pause period, a resume request, etc.

In operation 11, the SF may transmit a sensing result notify to a target NF such as an AF, etc. via the NEF. The sensing result notify may include a result of sensing data processing. For example, when an intrusion is detected in a specific area, a detection result may be notified, or vehicles passing through a specific area may be detected and the number of detected vehicles may be periodically notified. Also, for example, when the result of sensing data processing exceeds a specific maximum or minimum value, or when the number of sensing data processing exceeds a specific number after a certain point, the SF may notify the result to the target NF such as the AF, etc. via the NEF.

In operation 11a, when it is necessary to request sensing data processing from additional NFs such as the NWDAF, etc., the SF may process the sensing data as is or in part and transmit a result to the NWDAF, etc. according to a condition, and receive a result of further processing from the NWDAF, etc.

In operation 12, the NWDAF may transmit a sensing result notify to a target NF. The sensing result notify may include a result of sensing data processing. For example, when an intrusion is detected in a specific area, a detection result may be notified, or vehicles passing through a specific area may be detected and the number of detected vehicles may be periodically notified.

In operation 12a, the SF may receive the result of further processing of sensing data from the NWDAF, then process the sensing data again into sensing results, and when the sensing results meet a specific condition, notify the sensing results to the target NF such as the AF via the NEF.

FIGS. 5A and 5B illustrate a sensing data collection operation using a user plane in a case where a gNB is Rx according to various embodiments of the present disclosure.

FIGS. 5A and 5B correspond to a case where sensing mode 3, 4, or 5 is used, which is when a gNB is an Rx sensing entity. Depending on a sensing mode actually selected, the process of FIGS. 4A and 4B and a process of FIGS. 5A and 5B are combined and utilized simultaneously. This process may also be automatically changed and applied in response to changes in the environment, such as a change in the state of a network or movement of UEs.

In operation 1, the AF transmits a sensing request to the NEF. In this case, the sensing request may include a location/geographical condition, a time condition, accuracy requirements, etc. In detail, the sensing request may further include the following parameters:
Location;
Activation/deactivation time;
Service requester (for authentication to provide the service);
Installed sensors in the location (UE types and RAN node);
Sensor IDs;
required AoS (statically or dynamically);
Minimum/maximum number of sensors;
Assistance information;
Who-will-get-notification; and/or
results conditions.

In operation 2, the NEF may convert a geographical location condition in location condition to a condition used in 3GPP, such as cell location condition or the like. The NEF then transmits the sensing request received in operation 1 to the SF that is capable of collecting/processing sensing information. In this case, information included in the sensing request is the same as that received in operation 1, but the converted location condition is used as the location condition. Operation 2 may be omitted when the AF has a close relationship with the 5GS. When operation 2 is omitted, the location condition provided by the AF is a cell location condition or the like used in the 3GPP.

In operation 3, the SF may initially perform a sensing entity selection process. That is, the SF determines the number of UEs and the number of gNBs, based on a mode, a coverage UE, a gNB, and a priority/accuracy. The SF then transmits, to the AMF, a subscription request to continuously report information about UEs and gNBs that meet the location condition, and receives initially required information in a response.

In operation 4, the AMF may retrieve subscription information for each UE from the UDM and check whether each UE is able to support a sensing service. In addition, the AMF may check information with the PCF to check a policy condition to identify whether each UE is able to provide the sensing service. That is, the AMF may receive information such as information about whether a UE collects sensor data by using the control plane or the user plane when the UE transmits the sensing data to the CN. Because gNBs may also be utilized as sensing entities, when information about whether each gNB may be utilized as a sensing entity is recorded in the UDM, the AMF may check and retrieve this information from the UDM. When information about whether each gNB may be utilized as a sensing entity is recorded in the PCF, the AMF checks and retrieves this information from the PCF.

In operation 5, the AMF may identify gNBs and UEs that satisfy the location condition by taking into account the conditions identified in operation 4.

In operation 6, the AMF may notify the SF of the gNBs and UEs identified in operation 5 along with the location condition. The SF updates the sensing entity selection process. That is, the SF checks whether the accuracy condition is to be satisfied and controls the number of UEs and the number of gNBs.

In operation 7, the SF may transmit a sensing selection request to gNBs by reflecting a determination result in operation 6. The sensing selection request may include target gNBs and configuration parameters. The configuration parameters are parameters required for the gNBs to be utilized as Tx/Rx sensing entities, and may include Tx/Rx frequency, sensing signal generation period, sensing data report interval, whether to use the control plane for a sensing data reporting, and an AMF ID, an SMF ID, an SF ID, a sensor ID, a sensing service ID, etc., required when using the control plane. The configuration parameters may include whether to use the user plane for a sensing data reporting, and a UPF ID, an SF ID, a session ID, an SMF ID, an SF ID, a sensor ID, a sensing service ID, etc., required when using the user plane.

In operation 8, each gNB may perform sensing configuration according to the information received in operation 7 so that the gNB may act as a Tx/Rx sensing entity, and transmit, to the SF, a sensing selection response indicating completion of the sensing configuration. In this operation, an ID of each gNB may be included again in addition to the parameters received in operation 7. When the state of the gNB changes due to increased load, etc., making it difficult to fulfill the request received in operation 7, the gNB notifies the SF of this situation.

In operation 7a, the SF may transmit a sensing selection request to gNBs by reflecting the determination result in operation 6. The sensing selection request may include target gNB2s and configuration parameters. The configuration parameters are the parameters required for the gNB2s to be utilized as Tx sensing entities and may include Tx frequency, sensing signal generation period, etc.

In operation 8a, each gNB2 performs sensing configuration according to the information received in operation 7a so that the gNB2 may act as a Tx sensing entity, and transmits, to the SF, a sensing selection response indicating completion of the sensing configuration. In this operation, an ID of each gNB2 may be included again in addition to the parameters received in operation 7a.

In operation 7b, the SF may transmit a sensing selection request to UEs by reflecting the determination result in operation 6. The sensing selection request may include target UEs and configuration parameters. The configuration parameters are the parameters required for the UEs to be utilized as Tx sensing entities and may include Tx frequency, sensing signal generation period, etc.

In operation 8b, each UE performs sensing configuration according to the information received in operation 7b so that the UE2 may act as a Tx sensing entity, and transmits, to the SF, a sensing selection response indicating completion of the sensing configuration. In this operation, an ID of each UE may be included again in addition to the parameters received in operation 7b. When the state of the UE changes due to increased load, movement of the UE, etc., making it difficult to fulfill the request received in operation 7b, the UE notifies the SF of this situation.

In operation 8c, the SF performs a sensing entity selection update process according to the results obtained in operations 8, 8a, and 8b. The SF may check the accuracy condition and control the number of UEs and the number of gNBs. In this operation, when it is determined that the accuracy condition is not to be satisfied, the process may return to operation 3 in order to proceed.

In operation 9, each gNB may operate as an Rx sensing entity according to the information received in operation 7, and use the user plane to transmit sensing data to the SF. In this case, the sensing data may be transmitted from the gNB to the SF via the UPF. Depending on the information received in operation 7, additional signaling may be required to secure a transmission path required for transmitting the sensing data. In this case, special QoS settings for transmission of the sensing data may be applied to a PDU Session. In the special QoS settings, information about whether the sensing data is periodic data and a delay for transmission of Notification may be used.

In operation 10, the SF receives the sensing data via the path secured in operation 9 and collects/processes the received sensing data. The sensing data may include a transmitting gNB ID, a message type, and actual data. The message type may indicate periodic data, an event notification, management information, etc. in addition to indicating the Rx gNB. The periodic data may include whether the data is periodic, how long the period is, and the time to be used without the data being transmitted during the period. In the case of event notification format, priority, processing delay tolerance, etc. may be additionally included. The management information indicates whether the data is purely sensing data or information required for the management of a sensing entity. The information required for the management of the sensing entity may additionally include a reset request, a stop request, a pause period, a resume request, etc.

In operation 11, the SF transmits a sensing result notify to a target NF such as the AF, etc. via the NEF. The sensing result notify includes a result of sensing data processing. For example, when an intrusion is detected in a specific area, a detection result may be notified, or vehicles passing through a specific area may be detected and the number of detected vehicles may be periodically notified. Also, for example, when the result of sensing data processing exceeds a specific maximum or minimum value, or when the number of sensing data processing exceeds a specific number after a certain point, the SF may notify the result to the target NF such as the AF, etc. via the NEF.

In operation 11a, when it is necessary to request sensing data processing from additional NFs such as the NWDAF, etc., the SF may process the sensing data as is or in part and transmit a result to the NWDAF, etc. according to a condition, and receive a result of further processing from the NWDAF, etc.

In operation 12, the NWDAF transmits a sensing result notify to a target NF. The sensing result notify includes a result of sensing data processing. For example, when an intrusion is detected in a specific area, a detection result may be notified, or vehicles passing through a specific area may be detected and the number of detected vehicles may be periodically notified.

In operation 12a, the SF may receive the result of further processing of sensing data from the NWDAF, then process the sensing data again into sensing results, and when the sensing results meet a specific condition, notify the sensing results to the target NF such as the AF via the NEF.

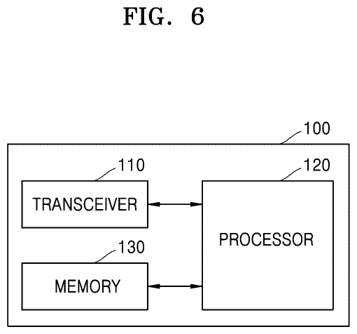

FIG. 6 illustrates a configuration of a network entity 100 according to various embodiments of the present disclosure. In an embodiment of the disclosure, the network entity 100 may correspond to the gNB, UE, AMF, UPF, SMF, PCF, SF, AF, or UDM described above.

Referring to FIG. 6, the network entity 100 may include a transceiver 110, a processor 120, and a memory 130. In accordance with the communication method of the network entity 100 described above, the transceiver 110, the processor 120, and the memory 130 of the network entity 100 may operate. However, the components of the network entity 100 are not limited to the above example. For example, the network entity 100 may include more or fewer components than those described above. In an embodiment of the disclosure, the transceiver 110, the processor 120, and the memory 130 may be implemented as a single chip. In addition, the processor 120 may include one or more processors.

The transceiver 110 collectively refers to a receiver of the network entity 100 and a transmitter of the network entity, and may transmit and receive signals to and from a UE or gNB. The signals transmitted to and received from the UE or gNB may include control information and data.

Furthermore, the transceiver 110 may perform functions for transmitting and receiving signals via a radio channel. For example, the transceiver 110 may receive a signal via a radio channel and output the signal to the processor 120 and transmit a signal output from the processor 120 via a radio channel.

The memory 130 may store data and programs necessary for operations of the network entity 100. Furthermore, the memory 130 may store control information or data in a signal obtained by the network entity 100. The memory 130 may include storage media such as read-only memory (ROM), random access memory (RAM), hard discs, compact disc ROM (CD-ROM), and digital versatile discs (DVDs), or a combination of the storage media. Furthermore, the memory 130 may not exist separately but may be included in the processor 120. The memory 130 may consist of volatile memory, non-volatile memory, or a combination of volatile and non-volatile memory. In addition, the memory 130 may provide stored data according to a request from the processor 120.

The processor 120 may control a series of processes such that the network entity 100 may operate according to the embodiment of the disclosure. For example, the processor 120 may receive control signals and data signals via the transceiver 110 and process the received control signals and data signals. The processor 120 may transmit the processed control signals and data signals via the transceiver 110. In addition, the processor 120 may write data to and read data from the memory 130. The processor 120 may perform functions of a protocol stack required by communication standards. For this purpose, the processor 120 may include at least one processor or microprocessor. In an embodiment of the disclosure, a part of the transceiver 110 or the processor 120 may be referred to as a communication processor (CP).

Thus, according to an embodiment of the disclosure, it is possible to collect sensing data obtained by a sensing entity for providing a sensing service within a 5GS by utilizing gNBs and UEs deployed for communication in the 3GPP 5GS.

The methods according to the embodiments of the disclosure described in the appended claims or specification of the disclosure may be implemented in hardware, software, or a combination of hardware and software.

When the methods are implemented in software, a computer-readable storage medium having at least one program (software module) stored therein may be provided. The at least one program stored in the computer-readable storage medium is configured for execution by at least one processor within an electronic device. The at least one program includes instructions that cause the electronic device to execute the methods according to the embodiments of the disclosure described in the claims or specification of the disclosure.

The program (software module or software) may be stored in RAM, non-volatile memory including a flash memory, ROM, electrically erasable programmable ROM (EEPROM), magnetic disc storage devices, CD-ROM, DVDs or other types of optical storage devices, and magnetic cassettes. Alternatively, the program may be stored in a memory that is configured as a combination of some or all of the stated devices. A plurality of such devices may be included in the memory.

Furthermore, the program may be stored in an attachable storage device that may be accessed through communication networks, such as the Internet, Intranet, a local area network (LAN), a wide area network (WAN), and a storage area network (SAN), or a communication network configured in a combination thereof. The storage device may connect to a device for performing a method according to an embodiment of the disclosure via an external port. Furthermore, a separate storage device on a communication network may also connect to a device for performing a method according to an embodiment of the disclosure.

In the specific embodiments of the disclosure described above, a component included in the disclosure is expressed in a singular or plural form depending on the presented specific embodiments. However, singular or plural expressions are selected to be suitable for the presented situations for convenience of descriptions, and the disclosure is not limited to elements in a singular or plural form, i.e., an element expressed in a plural form may be configured as a single element, or an element expressed in a singular form may be configured as a plurality of elements.

Moreover, while specific embodiments of the disclosure have been described in the detailed description of the disclosure, various modifications may be made therein without departing from the scope of the disclosure. Thus, the scope of the disclosure should not be limited to the described embodiments of the disclosure but be defined by the following claims as well as their equivalents.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by an access and mobility management function (AMF) in a wireless communication system, the method comprising:
receiving a subscription request from a sensing function (SF);
receiving, from unified data management (UDM), subscription information for each user equipment (UE) and determining whether each UE supports a sensing service;
identifying, based on the subscription information and a determination whether each UE supports the sensing service, at least one base station or at least one UE that satisfies a location condition; and
transmitting, to the SF, information related to the at least one base station or at least one UE and the location condition.

2. The method of claim 1, wherein the subscription request includes a request to continuously report information about UEs and base stations that satisfy the location condition.

3. The method of claim 1, further comprising transmitting a subscription response in response to the subscription request.

4. The method of claim 1, further comprising receiving information from a policy control function (PCF) and identifying whether each UE provides the sensing service through a policy condition.

5. The method of claim 4, wherein the information received from the PCF includes information about whether a UE collects sensor data by using a control plane or a user plane when the UE transmits sensing data to a core network (CN).

6. A method performed by sensing function (SF) in a wireless communication system, the method comprising:
receiving a sensing request from a network exposure function (NEF) including a location condition;
determining a number of user equipments (UEs) and a number of base stations for sensing based on a mode, a coverage UE, a base station, a priority, and an accuracy condition;
transmitting a subscription request to an access and mobility management function (AMF);
receiving, from the AMF, a subscription response in response to the subscription request; and
receiving, from the AMF, a location condition and information related to at least one base station or at least one UE that satisfies the location condition.

7. The method of claim 6, further comprising updating the number of UE and the number of base stations for sensing based on whether the accuracy condition is to be satisfied.

8. The method of claim 6, further comprising:
transmitting, to the at least one of the UE or the base stations for sensing, a sensing selection request including a number of UE and a number of base stations for sensing; and
receiving, from the at least one of the UE or the base stations for sensing, a sensing selection response in response to the sensing selection request.

9. The method of claim 8, wherein the sensing selection request further includes configuration parameters and information related to the at least one of target UEs or target base stations for sensing.

10. The method of claim 8, wherein the sensing selection response includes an indication indicating completion of sensing configuration.

11. The method of claim 8, further comprising updating the number of UE and the number of base stations for sensing based on whether the accuracy condition is to be satisfied.

12. The method of claim 6, further comprising receiving sensing data from at least one of the UE or the base stations for sensing.
